(19) United States
(12) Patent Application Publication
(10) Pub. No.: US 2022/0344960 A1
(43) Pub. Date: Oct. 27, 2022

(54) Method for the efficient discharge of a rechargeable battery

(71) Applicant: Hilti Aktiengesellschaft, Schaan (LI)

(72) Inventors: Stefan MAYER, Hurlach (DE); Klaus HAUSER, Schwabmuenchen (DE); David KOSCHECK, Augsburg (DE)

(21) Appl. No.: 17/642,357

(22) PCT Filed: Sep. 22, 2020
(86) PCT No.: PCT/EP2020/076383

§ 371 Date: Mar. 11, 2022

(30) Foreign Application Priority Data
Oct. 1, 2019 (EP) 19200696.3

(51) Int. Cl. H02J 7/00; H01M 10/42; H01M 10/48

(52) U.S. Cl. CPC H02J 7/007192; H02J 7/007182; H02J 7/00032; H01M 10/425; H01M 10/486; H01M 2220/30

(57) ABSTRACT

A method for the open-loop and closed-loop control of a power tool with at least one rechargeable battery, a drive and at least one control device, the rechargeable battery serving as an energy supply for the power tool. The method includes the method steps of: recording at least one temperature value of the rechargeable battery by a temperature measuring device; recording at least one first voltage value of the rechargeable battery by a voltage measuring device; and setting a first performance parameter value of the power tool to a second performance parameter value of the power tool for setting a current intensity value if the recorded temperature value corresponds to a predetermined temperature threshold value and the recorded voltage value corresponds to a predetermined voltage threshold value. A system including a power tool and at least one rechargeable battery for supplying the power tool with electrical energy for carrying out the method.

The present invention relates to a method for the open-loop and closed-loop control of a power tool with at least one rechargeable battery, a drive and at least one control device, the rechargeable battery serving as an energy supply for the power tool.

In addition, the present invention relates to a system comprising a power tool and at least one rechargeable battery for supplying the power tool with electrical energy for carrying out the method according to the invention.

### SUMMARY OF THE INVENTION

When using a rechargeable battery as a power supply for a power tool, the problem arises that the rechargeable battery is heated up by the internal resistance (also referred to as the output resistance) of the rechargeable battery cells when the electrical energy is delivered. For safety reasons, the delivery of the electrical energy from the rechargeable battery is ended when the rechargeable battery cells reach or exceed a critical temperature threshold value. The disadvantage here is that, when the temperature threshold value is reached, the rechargeable battery is often not yet fully discharged or there is still capacity (electrical voltage) in the rechargeable battery cells, which however is no longer available to the user of the power tool. In other words: due to the premature overheating of the rechargeable battery cells, the full capacity of the rechargeable battery cannot be used.

It is an object of the present invention provide a method for the open-loop and closed-loop control of a power tool with at least one rechargeable battery by which the aforementioned problem is solved and it can be ensured that the most effective possible use is made of the available capacity of a rechargeable battery as an energy supply for a power tool before the rechargeable battery cells overheat.

The present invention provides a method for the open-loop and closed-loop control of a power tool with at least one rechargeable battery, a drive and at least one control device, the rechargeable battery serving as an energy supply for the power tool.

According to the invention, the method comprises the method steps of
recording at least one temperature value of the rechargeable battery by a temperature measuring device;
recording at least one first voltage value of the rechargeable battery by a voltage measuring device; and
setting a first performance parameter value of the power tool to a second performance parameter value of the power tool for setting a current intensity value if the recorded temperature value corresponds to a predetermined temperature threshold value and the recorded voltage value corresponds to a predetermined voltage threshold value.

According to an advantageous embodiment of the present invention, it may be possible for the method to comprise the method steps of
storing the set current intensity value in a memory device of the rechargeable battery;
sending the current intensity value from the memory device of the rechargeable battery to the control device of the power tool; and
setting the current intensity value by setting at least one performance parameter value of the power tool when the rechargeable battery exceeds a predetermined charge value.

According to an advantageous embodiment of the present invention, it may be possible that the performance parameter of the power tool is a speed value of the drive or a torque value of the drive.

Furthermore, the present invention provides a system comprising a power tool and at least one rechargeable battery for supplying the power tool with electrical energy for carrying out the method.

Further advantages can be found in the following description of the figures. Various exemplary embodiments of the present invention are shown in the figures. The figures, the description and the claims contain numerous features in combination. A person skilled in the art will expediently also consider the features individually and combine them into useful further combinations.

### BRIEF DESCRIPTION OF THE DRAWINGS

In the figures:

FIG. 1 shows a cross section through a system according to the invention comprising a power tool with a connected rechargeable battery; and

FIG. 2 shows a graphic representation of the voltage drop, the temperature rise and the profile of the current intensity during the use of a rechargeable battery for supplying a power tool with electrical energy.

### DETAILED DESCRIPTION

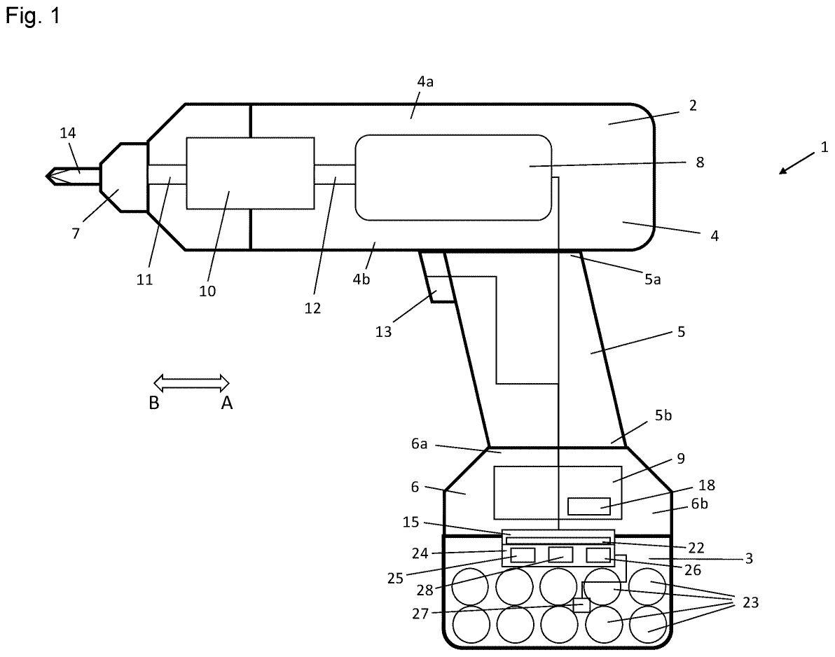

FIG. 1 illustrates a system 1 according to the invention with a power tool 2 and a rechargeable battery 3. The rechargeable battery 3 is connected to the power tool and serves for supplying the electrical loads of the power tool 2 with electrical energy. During the supply, electric current flows from the rechargeable battery 3 to the power tool 2.

According to an alternative embodiment of the present invention, the power tool 2 may not be supplied with electrical energy by at least one rechargeable battery but by a network connection. The network connection may also be referred to as a power cable. This alternative embodiment of the present invention is not shown in the figures.

As illustrated in FIG. 1, the power tool 2 is shown in the form of a rechargeable battery-operated screwdriver. According to other alternative embodiments, the power tool 2 may also be designed in the form of a power drill, a saw, a grinder or the like.

The power tool 2 designed as a rechargeable battery-operated screwdriver substantially comprises a housing 4, a handle 5, a base part 6, a tool fitting 7, an electrical drive 8 in the form of an electric motor, a control device 9, a transmission 9a, an input shaft 11, an output shaft 12 and an activation switch 13.

The electrical drive 8 designed as an electric motor, the transmission 10, the input shaft 11, the output shaft 12 and the control device 9 are positioned in the housing 4. The drive 8, the transmission 10, the input shaft 11 and the output shaft 12 are positioned in relation to one another and in the housing 10 such that a torque generated by the drive 8 is transmitted to the output shaft 12. The output shaft 12 transmits the torque to the transmission 10, which in turn passes on a torque to the input shaft 11. The tool fitting 7 is driven by way of the input shaft 11 by the transmission of the torque. As illustrated in FIG. 1, a tool 14 in the form of a bit is held in the tool fitting 7. By means of the bit, a screw can be screwed into a material. Neither the screw nor the material is illustrated in the figures.

As also shown in FIG. 1, the housing 4 comprises an upper side 4a and an underside 4b. The handle 5 comprises a first end 5a and a second end 5b. The first end 5a of the handle 5 is secured to the underside 4b of the housing 4. Furthermore, the base part 6 comprises an upper end 6a and a lower end 6b. The upper end 6a of the base part 6 is secured to the second end 5b of the handle 5. The lower end 6b of the base part 6 comprises a mechanical, electrical and electronic interface 15 and serves for mechanical, electrical and electronic connection to the rechargeable battery 3. For taking up electric current, the interface 15 comprises a number of power connections. The interface 15 additionally comprises data connections for transmitting and receiving signals between the power tool 2 and the rechargeable battery 3.

As can also be seen from FIG. 1, the control device 9 of the power tool 2 is positioned in the base part 6 of the power tool 2. The control device 9 of the power tool 2 serves for the open-loop and closed-loop control of various processes in relation to the power tool 2 and in relation to the rechargeable battery 3. The control device 9 controls in particular the current or the intensity of the current that flows from the rechargeable battery 3 to the power tool 2, and in particular is used for driving the drive 8 formed as an electric motor.

The control device 9 of the power tool 2 comprises a microcontroller 18 (also referred to as an MCU) and a data interface with a first transceiver as part of a communication circuit for communication (i.e. data and signal exchange) between the rechargeable battery 3 and the power tool 2.

The rechargeable battery 3 essentially comprises a housing 21 with a rechargeable battery interface 22, a plurality of energy storage cells 23, control electronics 24 and a temperature measuring device 27. The control electronics 24 in turn comprise a microcontroller 25, a voltage measuring device 26 and a memory device 28.

The temperature measuring device 27 may also be referred to as a temperature sensor.

The rechargeable battery 3 also comprises a data interface with a second transceiver as a component part of a communication circuit for communication between the rechargeable battery 3 and the power tool 2.

The energy storage cells 23 may also be referred to as rechargeable battery cells and serve for taking up, storing and providing electrical energy or an electrical voltage.

The rechargeable battery interface 22 is positioned on one side of the housing 21. The rechargeable battery interface 22 comprises a number of power connectors for taking up and delivering electric current and also data connectors for transmitting and receiving signals between the power tool 2 and the rechargeable battery 3. The electric current from the energy storage cells 23 can be delivered by way of the power connectors.

As shown in FIG. 1, the power tool 2 is connected to the rechargeable battery 3, so that the power connectors of the rechargeable battery 3 are also connected to the power connections of the power tool 2. Similarly, the data connectors of the rechargeable battery 3 are connected to the data connections of the power tool 2.

Through the connection, electric current can flow from the energy storage cells 23 of the rechargeable battery 3 to the power tool 2. Furthermore, signals can be exchanged for communication between the rechargeable battery 3 and the power tool 2.

As can be seen from FIG. 1, the activation switch 13 is positioned on a front side 5c of the handle 5. As a result of the activation switch 13 being moved in direction A, a signal can be transmitted from the activation switch 13 to the controller 9, as a result of which the controller 9 in turn transmits a signal to the control electronics 24 of the rechargeable battery 3. The signal transmitted to the control electronics 24 enables the release of electrical energy or electric current with a specific current value from the rechargeable battery 3 for the electrical load of the power tool 2 and in particular the drive 8 formed as an electric motor. The power tool 2 has a current device (not shown) with which the current intensity of the supply current can be measured. If a supply current with a permissible current intensity is measured, the supply current can flow to the electrical loads of the power tool 2. Alternatively or additionally, the current measuring device may also be positioned in the rechargeable battery 3.

In order to transmit a signal corresponding to the travel of the activation switch 13 in direction A to the controller 9, the activation switch 13 comprises a potentiometer (not shown).

If the activation switch 13 moves again in direction B, a corresponding signal is transmitted to the controller 9 with the aid of the potentiometer (not shown), with the result that electric current no longer flows from the rechargeable battery 3 to the power tool 2.

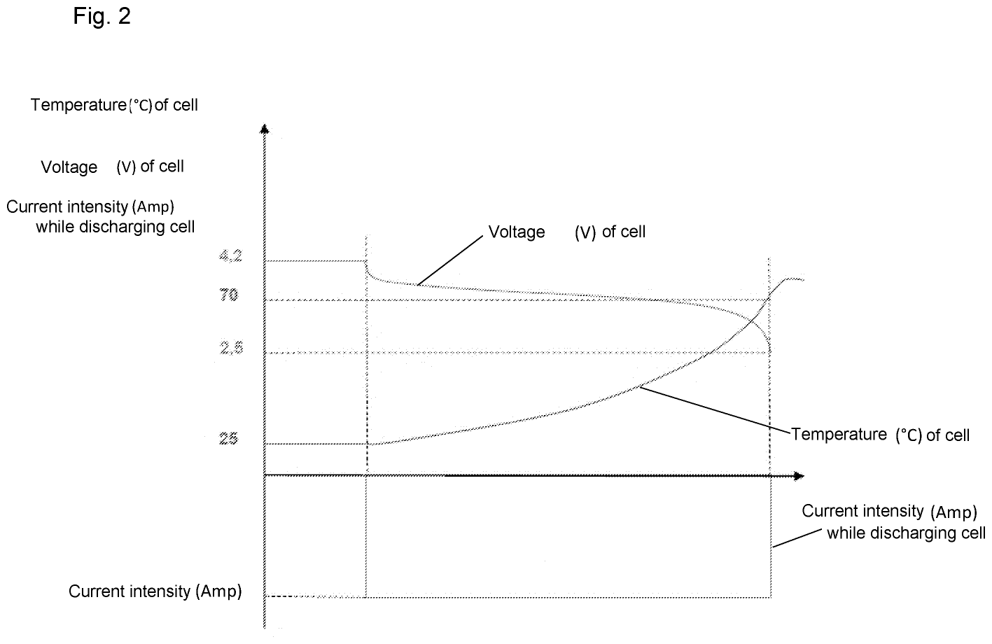

During the delivery of electrical energy, the energy storage cells 23 heat up. The temperature profile of the rechargeable battery cells (see FIG. 2) is recorded by means of the temperature measuring device 27. During the delivery of electrical energy from the rechargeable battery to the power tool, the temperature of the rechargeable battery cells is usually between 25° C. and 70° C. The voltage at each rechargeable battery cell is recorded by means of the voltage measuring device 26. In a charged state, the voltage of a rechargeable battery cell is 4.2 volts and in a discharged state it is 2.5 volts.

In the event that the temperature of the rechargeable battery cells rises above 70° C. and the voltage of a rechargeable battery cell falls below 2.5 volts, the control electronics 24 of the rechargeable battery 3 stop the delivery of electrical energy to the power tool 2.

In order to prevent the delivery of electrical energy from the rechargeable battery to the power tool being ended due to a critical temperature threshold value of the rechargeable battery cells 23 being reached too early, the power of the power tool is reduced accordingly. For this purpose, the speed of the drive 8 is reduced with the aid of the control device 9. By reducing the speed of the drive 9, the value of the current intensity that flows from the rechargeable battery cells 23 to the drive 8 of the power tool is reduced. Due to the lower intensity of the current, the temperature rise at the rechargeable battery cells slows down, so that electrical voltage (i.e. electrical energy) can be drawn from the rechargeable battery cells for a longer period of time.

Furthermore, the value of the current intensity with which the slowest possible rise in temperature in the rechargeable battery cells 23 is achieved is stored in the memory device 28 of the rechargeable battery 3. When the rechargeable battery 3 is fully charged to be used again as a power supply for a power tool 2, the value of the current intensity with which the slowest possible temperature rise in the rechargeable battery cells 23 is achieved is sent to the control device 9 of the power tool 2. With the help of this determined current intensity value, the power output of the drive 8 can be set or selected right at the beginning of the use of the charged battery 3 in such a way that the temperature at the rechargeable battery cells 23 is prevented from increasing too quickly and the rechargeable battery cells 23 are discharged almost completely.

What is claimed is:

1-4. (canceled)

5: A method for the open-loop and closed-loop control of a power tool with at least one rechargeable battery, a drive and at least one control device, the rechargeable battery serving as an energy supply for the power tool, the method comprising the steps of:
recording at least one temperature value of the rechargeable battery by a temperature measuring device;
recording at least one first voltage value of the rechargeable battery by a voltage measuring device; and
setting a first performance parameter value of the power tool to a second performance parameter value of the power tool for setting a current intensity value if the recorded temperature value corresponds to a predetermined temperature threshold value and the recorded voltage value corresponds to a predetermined voltage threshold value.

6: The method as recited in claim 5 further comprising:
storing the set current intensity value in a memory device of the rechargeable battery;
sending the current intensity value from the memory device of the rechargeable battery to the control device of the power tool; and
setting the current intensity value by setting at least one performance parameter value of the power tool when the rechargeable battery exceeds a predetermined charge value.

7: The method as recited in claim 5 wherein the first and second performance parameter values are speed values of the drive or torque values of the drive.

8: A system comprising a power tool and at least one rechargeable battery for supplying the power tool with electrical energy for carrying out the method as recited in claim 5.
